(19) United States
(12) Patent Application Publication
(10) Pub. No.: US 2011/0178688 A1
(43) Pub. Date: Jul. 21, 2011

(54) Method and Device for Hydraulic Brake Boosting

(76) Inventors: Josef Knechtges, Mayen (DE); Frank Heller, Boppard (DE)

(21) Appl. No.: 13/057,540

(22) PCT Filed: Jul. 22, 2009
(86) PCT No.: PCT/EP2009/005321

§ 371 Date: Mar. 21, 2011

(30) Foreign Application Priority Data
Aug. 6, 2008 (DE) 10 2008 036 607.2

(51) Int. Cl. B60T 8/172; F16D 65/32

(52) U.S. Cl. 701/70

(57) ABSTRACT

A technique for boosting hydraulic brake pressure in a hydraulic motor vehicle brake system is proposed, wherein a first pressure component of a brake pressure in the brake system is generated in a driver-controlled manner. A method in this respect comprises the steps of acquiring a deceleration value that indicates a deceleration of the vehicle and generating an additional second pressure component as a function of the deceleration value.

### CROSS-REFERENCE TO RELATED APPLICATIONS

This application is a national stage of International Application No. PCT/EP2009/005321 filed Jul. 22, 2009, the disclosure of which is incorporated herein by reference, and which claimed priority to German Patent Application No. 10 2008 036 607.2 filed Aug. 6, 2008, the disclosure of which is incorporated herein by reference.

### BACKGROUND OF THE INVENTION

The invention relates generally to a brake assist device. In particular, the invention relates to a hydraulic brake boosting technique for a vehicle brake system.

So-called brake assist devices, which have the task of optimizing a driver-controlled braking operation upon detection of the existence of a hazardous situation, are prior art. A hazardous situation is detected for example from a characteristic profile of a driver-controlled actuation of the brake system. For this purpose in a hydraulic brake system, in which the driver for braking purposes generates a pressure in a master cylinder, the driver-controlled actuation of the brake system may be determined with the aid of a pressure sensor that acquires the pressure prevailing in the master cylinder. In this way, a hazardous situation is detected if the master cylinder pressure rises at a rate lying above a predetermined threshold value (panic braking operation).

In the event of detection of a hazardous situation to optimize the braking operation, known brake assist devices generally initiate an ABS braking operation. In other words, a hydraulic pressure in the brake system is increased independently of the driver to such an extent that the brake system of the motor vehicle generates a maximum brake application force at the wheel brakes. At the same time an ABS system, by suitably influencing the actuating pressures at the wheel brakes, prevents a loss of directional stability of the motor vehicle.

As current hydraulic motor vehicle brake systems are equipped with ABS- or ESC systems (electronic stability control), all of the parts necessary for assisting a braking operation by means of a brake assist device are already installed. However, for use of a brake assist device it is necessary that the pressure in the master cylinder is determined very reliably in order to avoid erroneous brake assist operations. The high-quality pressure sensors or redundant pressure sensors installed for this reason do however significantly increase the cost of the brake system.

There are moreover hydraulic brake systems, which for cost reasons have to manage entirely without a sensor for the master cylinder pressure. In these brake systems, therefore, hydraulic brake assist devices have hitherto not been implemented.

The object of the invention is therefore to provide a technique, by means of which the previously mentioned limitations are overcome in order to implement a brake assist function in a motor vehicle brake system.

### BRIEF SUMMARY OF THE INVENTION

According to a first aspect, a method of boosting hydraulic brake pressure in a hydraulic motor vehicle brake system, wherein a first pressure component of a brake pressure in the brake system is generated in a driver-controlled manner, comprises the steps of acquiring a deceleration value that indicates a deceleration of the vehicle and generating an additional second pressure component as a function of the deceleration value.

The driver-controlled generation of the first pressure component may comprise a mechanical or pneumatic brake boosting by means of a brake booster disposed upstream of the master cylinder. The deceleration value that indicates the deceleration of the motor vehicle may be derived from a velocity of the motor vehicle. The deceleration value may be derived indirectly or directly from at least one signal of at least one wheel speed sensor. The deceleration value may alternatively or additionally be determined on the basis of one or more other sensor signals.

The second pressure component may be generated in such a way that it is substantially proportional to the first pressure component. Alternatively, there may be a different relationship between the first and the second pressure component, for example with an at least partially exponential or logarithmic progression. There may also be a constant difference (“offset”) between the two pressure components and/or a second pressure component of a constant amount may be used.

The second pressure component may be generated as a function of an absolute value or a rate of change of the deceleration value. In this case, the method may comprise a comparison of the acquired deceleration value with a threshold value. The threshold value may be predetermined or dependent upon parameters. The comparison with the threshold value may also be dependent upon further conditions, for example an absolute deceleration of the motor vehicle or an absolute brake pressure and/or brake pressure component.

The method may further comprise the step of controlling a pressure supply device for generating the second pressure component. This control may comprise activating and/or deactivating an electrically operated pump and/or opening and/or closing a feed line of an accumulator (for example a diaphragm accumulator) for pressurized hydraulic fluid (for example by means of an electrically actuated valve).

The method may further comprise the step of limiting the second pressure component and/or the brake pressure. This step may include controlling a pressure limiting device, for example an ISO valve. A value, to which the second pressure component and/or the brake pressure is limited, may be predetermined or dependent upon parameters.

The method may further comprise the step of determining a first pressure value, which is associated with the first pressure component, on the basis of the deceleration value. In this case the brake system, if need be, may be designed without a pressure sensor (and hence economically). The first pressure value may also be supplied to further components of the vehicle.

The method may also comprise the step of checking a plausibility of a second pressure value, which is determined by means of a pressure sensor and associated with the first pressure component. In this case, account may be taken of the fact that the first pressure value associated with the first pressure component varies more slowly and/or with a time delay compared to the second pressure value determined by means of the pressure sensor. This difference may be caused by a flow behaviour of a hydraulic fluid (for example due to throttling) in a hydraulic system.

The method may comprise the step of comparing the first pressure value with the second pressure value. The comparison may be preceded by a scaling and/or loading with a constant addend of one or both signals in such a way that the two pressure values are substantially equal if the brake system is fault-free. The comparison may also be preceded by a time delay of measured values of one of the two signals in order to take the flow behaviour of the hydraulic fluid into account.

If a lack of plausibility of the second pressure value is determined, the method may comprise the step of outputting an alarm signal. The alarm signal may be directed to a driver of the motor vehicle and may comprise for example a visual, audible and/or haptic alarm. The step of outputting an alarm may also comprise writing a message in an error memory. A functionality of a hydraulic brake assist device may further be deactivated if a lack of plausibility has been determined.

According to a second aspect, a computer program product having program code means is provided for executing the previously described method when the computer program product runs on a processing unit (for example an electrical control unit, also known as an ECU). Such a processing unit may control further braking functionalities of the motor vehicle, for example ABS or ESP.

The computer program product may be stored on a computer-readable data carrier. For example the computer program product may be stored on a mobile data carrier, such as for example a diskette, a hard disk, a CD or DVD, or on a stationary data carrier, such as for example a semiconductor memory (for example a RAM, ROM, EPROM, EEPROM, NOVRAM or FLASH).

A third aspect comprises a device for boosting hydraulic brake pressure in a hydraulic motor vehicle brake system, wherein a first pressure component of a brake pressure in the brake system may be generated in a driver-controlled manner, an acquisition detection device for acquiring a deceleration value that indicates a deceleration of the vehicle, and a generating device for generating an additional second pressure component of the brake pressure as a function of the deceleration value. The acquisition device may comprise for example sensors that acquire a wheel speed signal of at least one wheel of the motor vehicle and/or directly acquire a vehicle velocity. The generating device may comprise for example an electrically actuated pump.

The device may further comprise a determination device for determining a first pressure value, which is associated with the first pressure component, on the basis of the deceleration value. The determination device may provide a signal corresponding to the first pressure value.

The device may comprise a plausibility checking device for checking the plausibility of a second pressure value, which is determined by means of a pressure sensor and associated with the first pressure component. The plausibility checking device may be configured with the determination device as a common processing unit.

The device may moreover comprise a limiting device for limiting the second pressure component and/or the brake pressure. The limiting device may be controllable, for example by means of an electrical signal, such as a pulse width (PWM-) signal, a current, a voltage or a frequency of an electrical signal.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a diagrammatic overall view of a first embodiment of a motor vehicle brake system;

FIG. 2 is a variation of the motor vehicle brake system of FIG. 1;

FIG. 3 is a hydraulic block diagram of a hydraulic hydraulics unit in a motor vehicle brake system according to one of FIGS. 1 and 2 in a normal position;

FIG. 4 is the hydraulics unit according to FIG. 3 during a hydraulic brake boosting operation;

FIG. 5 is a flowchart of an embodiment of a method of boosting the brake pressure in a motor vehicle brake system according to one of FIGS. 1 and 2; and

FIG. 6 is examples of characteristics of parameters in a hydraulics unit according to FIG. 4 during a hydraulic brake boosting operation.

In the figures identical and/or mutually corresponding elements bear the same reference characters.

### DETAILED DESCRIPTION OF THE INVENTION

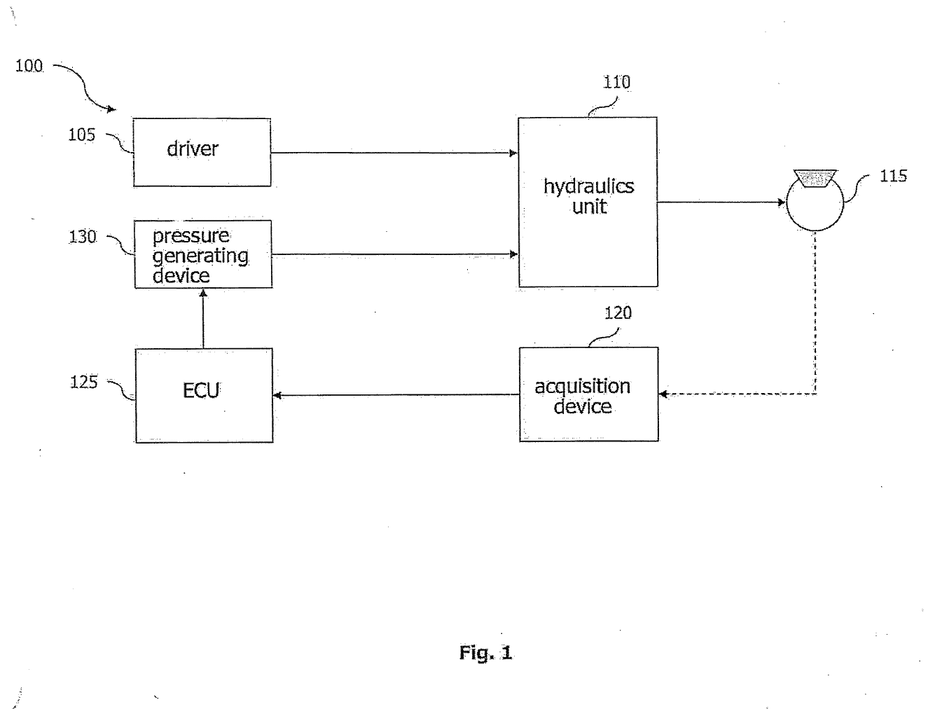

FIG. 1 shows an embodiment of a hydraulic motor vehicle brake system 100, which is actuated by a driver 105 and comprises a hydraulics unit 110, at least one wheel brake 115, an acquisition device 120, an electronic control unit (ECU) 125 and a pressure generating device 130.

By means of the hydraulics unit 110 the driver 105 generates a first brake pressure component. A second pressure component in the hydraulics unit 110 is generated by means of the pressure generating unit 130. By means of the summed pressure components the hydraulics unit 110 brings about an actuation of the wheel brake 115. Although the following description is based upon only a single wheel brake 115, any number of optionally individually actuable wheel brakes 115 may be actuated by means of the hydraulics unit 110.

When the wheel brake 115 is actuated, the motor vehicle (not represented), in which all of the represented components are situated, is braked and hence decelerated. In this way the wheel brake 115 acts indirectly upon the acquisition unit 120, which acquires the deceleration of the motor vehicle. This relationship is indicated in FIG. 1 by the dashed arrow. The acquisition device 120 may process for example measured velocity values or measured values of one or more wheel speed sensors of the motor vehicle. The electronic control unit 125 on the basis of a deceleration value supplied by the acquisition device 120 controls the pressure generating device 130, which generates the second pressure component of the brake pressure.

By means of the arrangement represented in FIG. 1 a hydraulic brake assist device, which manages without a pressure sensor for determining a driver-controlled pressure, may be integrated in a motor vehicle brake system 100 in the manner described below.

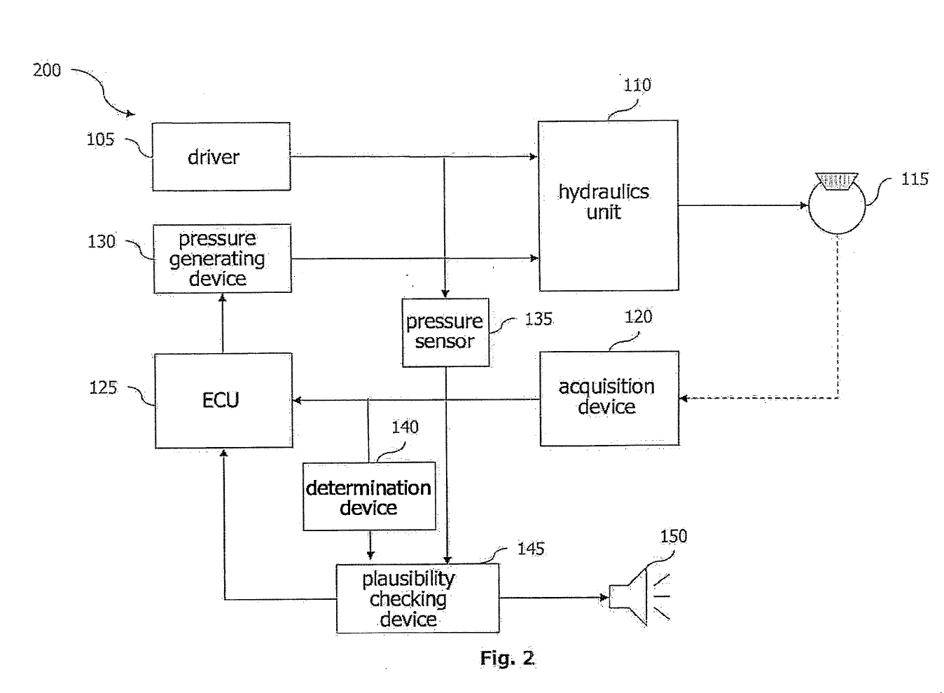

FIG. 2 shows a further embodiment of a hydraulic motor vehicle brake system 200 that is an extension of the hydraulic motor vehicle brake system 100 shown in FIG. 1. In addition to the elements of the brake system 100 already described in connection with FIG. 1, the motor vehicle brake system 200 comprises a pressure sensor 135, a determination device 140, a plausibility checking device 145 and an alarm device 150.

By means of the determination device 140, in the manner described in connection with FIG. 1 a first pressure value of the first pressure component—generated by the driver 105—(of the master cylinder pressure) of the hydraulics unit 110 is determined on the basis of the deceleration signal supplied by the acquisition device 120. Furthermore, by means of the sensor 135 a second pressure value of the first pressure component is acquired. The two pressure values are supplied to the plausibility checking device 145 to check the plausibility.

The plausibility checking device 145 determines a plausibility of the second pressure value supplied by the pressure sensor 135 on the basis of the first pressure value supplied by the determination device 140. As a result of this plausibility check the plausibility checking device 145 supplies a plausibility signal to the ECU 125. In the event of a successful plausibility check, the second pressure value supplied by the pressure sensor 135 is identified as valid and forms the basis of subsequent control- or regulating mechanisms. These mechanisms may comprise in particular the, as such, known functionality of a hydraulic brake assist device. The plausibility checking device 145 is further configured, in the event of a lack of plausibility of the second pressure value, to output an alarm by means of the alarm device 150 and/or to overwrite the second pressure value with the first pressure value.

By virtue of the plausibility check carried out by the checking device 140 it is possible to use in the brake system 200 a (low-cost) standard-quality pressure sensor 135 to control the hydraulic brake assist device, and to ensure a high operational reliability of the functionality of a hydraulic brake assist device by virtue of checking the plausibility of a master cylinder pressure value by means of the checking device 145.

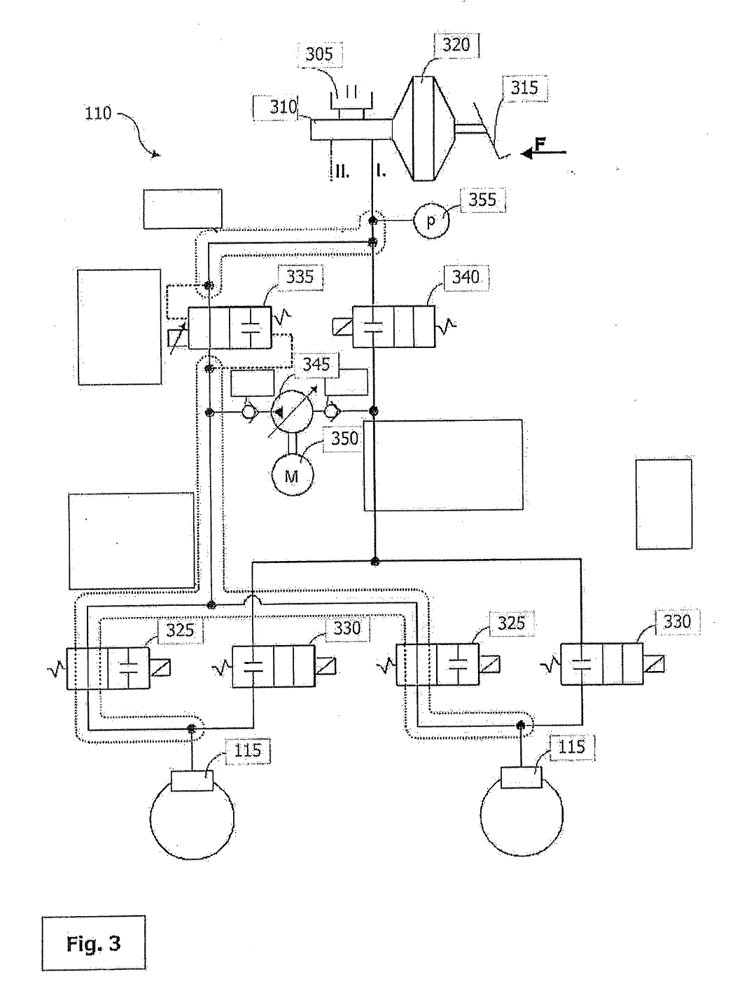

FIG. 3 shows details of the hydraulic hydraulics unit 110 of FIGS. 1 and 2 in a normal position. The hydraulics unit 110 operates by means of a hydraulic fluid that is in part stored in a container 305. To generate brake pressure, which arises by pressurizing the hydraulic fluid, a master (brake) cylinder 310 is used, which is to be actuated by the driver (not represented) by means of a pedal 315. The force F introduced by the driver is pneumatically boosted by means of a brake booster 320.

From the master cylinder 310 a first and a second brake circuit I., II. are supplied, wherein each brake circuit comprises two wheel brakes 115. As the brake circuits I., II. are of a substantially identical construction, only the first brake circuit I. is represented in detail here. Depending upon which wheel brakes of the motor vehicle are supplied by which brake circuit, the result is a front/rear axle split, i.e. the one brake circuit supplies the wheel brakes of the front axle and the other brake circuit supplies the wheel brakes of the rear axle, or a diagonal split, i.e. each brake circuit supplies the wheel brake of one front wheel and the wheel brake of the diagonally opposite rear wheel. For the present embodiments an individual modulation of the brake pressure in the wheel brakes 115 is of no significance, for which reason the following description does not differentiate between the wheel brakes 115.

The hydraulic connection from the master cylinder 310 to the wheel brakes 115 is determined by 2/2-way valves 325, 330, 335 and 340, which are actuated by electromagnets and in the non-actuated, i.e. electrically non-activated state occupy the normal positions represented in FIG. 3. Here, normal position means in particular that the valves 325 and 335 each occupy their let-through position, whilst the valves 330 and 340 each occupy their blocking position.

For carrying out service braking operations by means of the hydraulics unit 110, in the represented normal position of the valves 325, 330, 335 and 340 a direct hydraulic connection exists between the master cylinder 310 and the wheel brakes 115. Thus, in the actuated state of the brake pedal 315 a brake pressure, the value of which is dependent upon the force F introduced by the driver 105, prevails in the wheel brakes 115.

The pressure prevailing in the master cylinder 310 is acquired by means of an optional pressure sensor 355. The pressure sensor 355 may be omitted in the embodiment according to FIG. 1.

The hydraulics unit 110 represented in FIG. 3 is, as such, prior art and is installed in motor vehicles in order to realize an ABS- and/or ESP functionality. The modes of operation known in this respect, in particular the control method of the valves 325-340 and of the electric motor 350 during a pressure building-, pressure holding- and pressure reducing phase at the wheel brake 115, are therefore not described at this point.

If the driver—starting from or instead of a service braking operation—carries out a panic braking operation, then this may be detected for example from a pressure rise in the master cylinder 310 that is faster than a predetermined dimension. In this situation an automatic hydraulic boosting of the brake pressure is carried out in order to assist the driver.

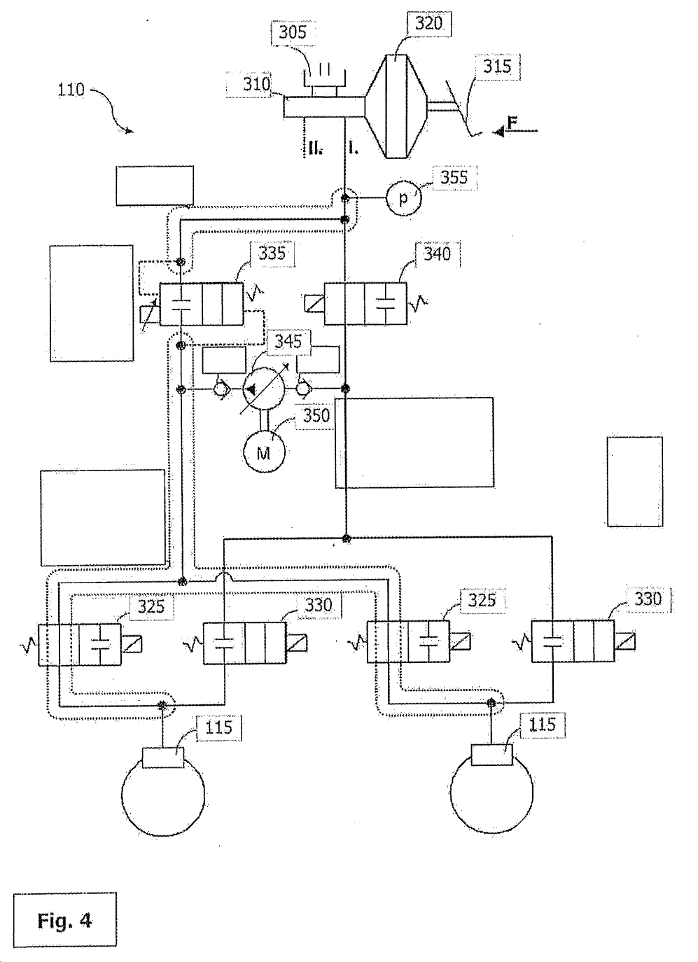

FIG. 4 shows the hydraulics unit of FIG. 3 during such a hydraulic brake boosting operation. Unlike FIG. 3, the pressure control valve 335 is in a blocking position and the valve 340 is in a let-through position; an electric motor 350 moreover actuates a pump 345 to generate an additional pressure component.

In the position of the pressure control valve 335 shown in FIG. 4 there is no direct hydraulic connection between the master cylinder 310 and the wheel brakes 115. Instead, the valve 340 releases a hydraulic connection from the master cylinder 310 to a suction side of the pump 345. The pump 345, which is configured for example as a radial piston pump, is used to increase a brake pressure component that is made available to the wheel brakes 115 and goes back to the driver. The electromotive pump 345 is blocking counter to its delivery direction. As the rotational speed of the electric motor 350 is conventionally adjustable and/or controllable, the delivery rate of the pump 345 may be adjusted. It is also customary for the electric motor 350 simultaneously to actuate the pump of the second brake circuit II., which is not represented in detail here.

From the master cylinder 310 the pump 345 draws in hydraulic fluid that is already under the driver-generated pressure. Over and above this pressure component the pump 345 generates an additional pressure component, so that at the discharge end of the pump 345 hydraulic fluid is supplied under a pressure that comprises a first, driver-controlled component and a second component generated by the pump 345. The hydraulic fluid under this cumulative pressure finally acts upon the wheel brakes 115 such that they brake the motor vehicle (not represented).

The valve 335 is an electronically adjustable pressure control valve (“ISO valve”). As a function of an electrical control signal (for example a pulse-width-modulated signal) a maximum pressure difference between an inlet- and an outlet side of the pressure control valve 335 is adjusted. If the existing pressure difference exceeds the adjusted value, then the closed pressure control valve 335 opens automatically.

Whereas the first pressure component going back to the driver acts identically upon both sides of the pressure control valve 335—directly upon the inlet side, indirectly by means of the valve 340 and the pump 345 upon the outlet side, the second pressure component generated by the pump 345 acts only upon the inlet side of the pressure control valve 335. A change of the first pressure component going back to the driver therefore has no effect upon the pressure limiting by means of the pressure control valve 335, rather the driver-controlled pressure component of the brake pressure is independent of the pressure limiting function. Thus, in the event of a variation of the first, driver-controlled pressure component, the total brake pressure acting upon the wheel brakes 115 and hence also the deceleration a of the motor vehicle varies in accordance with the variation. Given a constant activation of the pressure control valve 335 and the motor 350, there is therefore a proportionality between the vehicle deceleration a (and/or a parameter indicating this) and the first pressure component prevailing in the master cylinder 310. Given a known activation of the pressure control valve 335 and motor 350, then a driver-controlled, first pressure component may be concluded from a specific deceleration a.

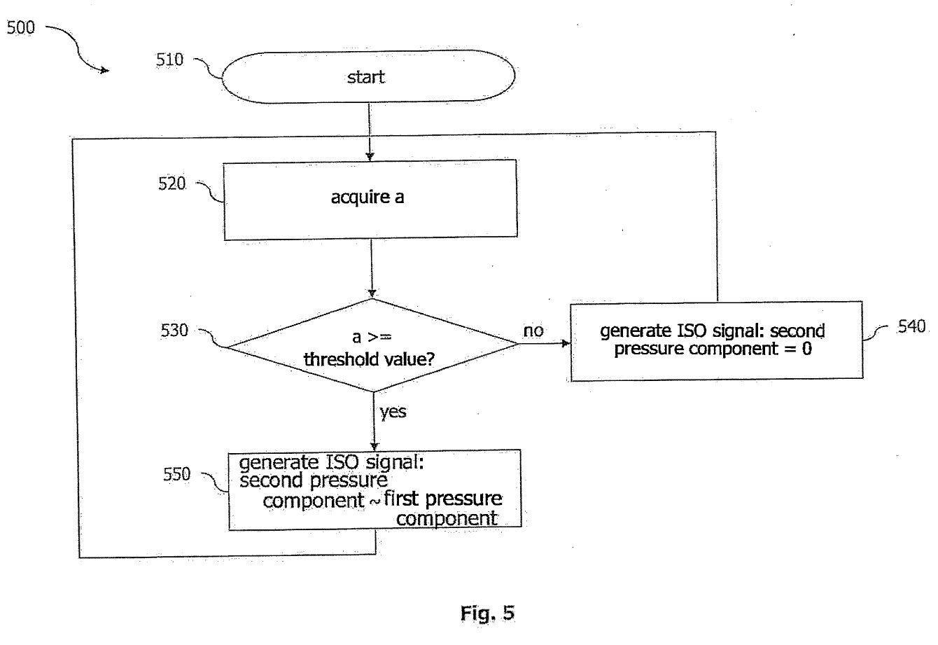

FIG. 5 shows a flowchart 500 of a method of boosting the brake pressure in a motor vehicle brake system such as that of FIG. 1 or 2. The method starts in a step 510. In a following step 520 a vehicle deceleration a is acquired. This is compared in a following step 530 with a threshold value. If the deceleration a is below the threshold value, then the method continues with a step 540, in which a pressure supply device is activated in such a way that the pressure it generates is 0. The method then returns to the step 520.

If however in step 530 it is determined that the deceleration value a is greater than or equal to the threshold value, then the method continues with a step 550. In this step the pressure supply device is activated in such a way that the second pressure component it generates is for example proportional to the first pressure component. The method then continues afresh with step 520.

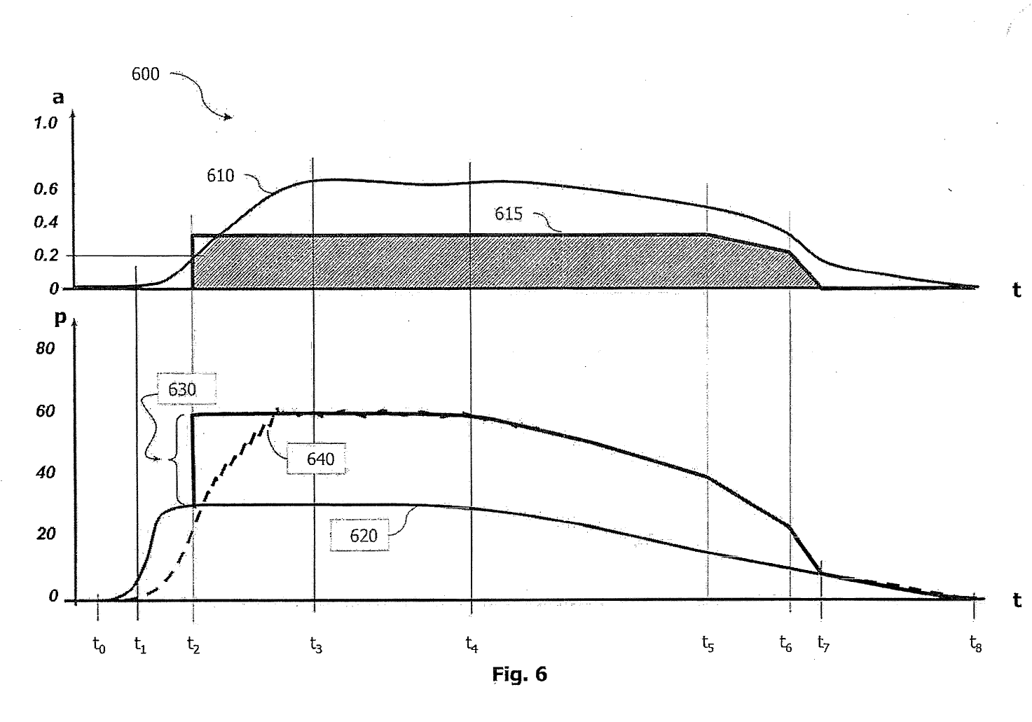

FIG. 6 shows examples of characteristics of a deceleration of a motor vehicle and various pressures during a braking operation with hydraulic brake boosting in a motor vehicle brake system as in FIG. 1 or 2.

The top and the bottom part of FIG. 6 refer to a common, horizontally extending time axis t. In the top part of FIG. 6 a deceleration (a in[g]) is presented in vertical direction. A characteristic of a vehicle deceleration 610 and a component 615 of a boosting pressure 630 supplied by the pump 345 are plotted. In the bottom part of FIG. 6 a pressure (p in [bar]) is presented in vertical direction. Here, a characteristic of a master cylinder pressure 620 in the master cylinder 310 of FIG. 4 (first pressure component), a characteristic of a boosting pressure 630 (second pressure component) generated by the pump 345 of FIG. 4, and a characteristic of a wheel brake pressure 640 (dashed line) at a wheel brake 115 of FIGS. 1 to 3 are plotted. It should be noted that in the bottom part of FIG. 6 the boosting pressure 630 is represented with reference to the master cylinder pressure 620, so that in FIG. 6 the brake pressure available at the output of the pump 345 is directly readable as the sum of the master cylinder pressure 620 and the boosting pressure 630.

At a time t₀ the master cylinder pressure 620 starts to rise as a result of an actuation of the hydraulics unit 110 by the driver 105. After a brief delay, which is caused by the flow behaviour of hydraulic fluid through the hydraulics unit 110, from a time t₁ the wheel brake pressure 640 and the vehicle deceleration 610 also rise.

At a time t₂, which is dimensioned in accordance with when the deceleration 610 has reached a predetermined value (here: 0.2 g), it is checked whether the deceleration 610 is rising faster than a predetermined dimension. This process corresponds to step 420 in FIG. 5. In the illustrated example this is the case, so that from the time t₂ the boosting pressure 630 is generated by means of the pump 345 (cf. step 450 in FIG. 5).

As a result of the additional boosting pressure 630, after a slight delay (see above) the wheel brake pressure 640 also rises more strongly until it finds a maximum at the pressure value corresponding to the sum of the master cylinder pressure 620 and the boosting pressure 630. The slight fluctuations superimposed on the wheel brake pressure 640 originate from a pressure modulation of an ABS- and/or ESP system and are of no further importance in the present context. In an analogous manner to the wheel brake pressure 640 the vehicle deceleration 610 also rises.

At a time t₃ both the wheel brake pressure 640 and the deceleration 610 have reached their respective maximum. Up to the time t₄ the values 610-640 remain substantially constant. At the time t₄ the master cylinder pressure 620 under the control of the driver starts to drop. In a corresponding manner the wheel brake pressure 640 and the deceleration 610 also fall. The boosting pressure 630 however remains—in relation to the master cylinder pressure 620—initially substantially constant.

The time t₅ is dimensioned in accordance with when the component of the master cylinder pressure 620 in the deceleration of the vehicle is less than 50%. From this time on, the boosting pressure 630 is reduced in proportion to the decrease of the master cylinder pressure 620. Consequently the deceleration component 615 also reduces, and the wheel brake pressure 640 and the deceleration 610 decrease further.

The time t₆ is defined by the boosting pressure 630 becoming lower than a predetermined threshold (here: 20 bar), and/or by the deceleration of the motor vehicle, which is brought about by the boosting pressure 630, dropping to a value lower than a predetermined value (here: 0.2 g). From the time t₆ the boosting pressure 630 is reduced in a ramp-shaped manner to a value of 0, whereupon the deceleration component 615 also drops to 0. In the representation shown, the boosting pressure 630 (and hence also the deceleration component 615) at the time t₇ reaches the value 0. Up to the end of the braking operation at the time t₈, the wheel brake pressure 640 therefore merely follows the master cylinder pressure 620. In a corresponding manner the deceleration 610 also drops only slowly to 0 between the time t₇ and t₈.

By virtue of the proposed technique it is possible to implement a hydraulic brake assist device in a hydraulic motor vehicle brake system that manages entirely without a sensor or with a simple (and low-cost) sensor for determining a master cylinder pressure. This means on the one hand that production costs may be saved and on the other hand that vehicles, which already have ABS- and/or ESP systems of the described preconditions, may with little outlay be retrofitted with a hydraulic brake assist device.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Method of boosting the hydraulic brake pressure in a hydraulic motor vehicle brake system, wherein a first pressure component of a brake pressure in the brake system is generated in a driver-controlled manner, comprising the following steps:
acquiring a deceleration value that indicates a deceleration of the vehicle; and
generating an additional second pressure component as a function of the deceleration value in such a way that the second pressure component is substantially proportional to the first pressure component.

2. Method according to claim 1, wherein the second pressure component is generated as a function of one of an absolute value and a rate of change of the deceleration value.

3. Method according to claim 1, further comprising the step of activating a pressure supply device for generating the second pressure component.

4. Method according to claim 1, further comprising the step of limiting one of the second pressure component and the brake pressure.

5. Method according to claim 1, further comprising the step of determining a first pressure value, which is associated with the first pressure component, on the basis of the deceleration value.

6. Method according to claim 1, further comprising the step of checking a plausibility of a second pressure value which is determined by means of a pressure sensor and associated with the first pressure component.

7. Method according to claim 6, further comprising the step of comparing the first pressure value with the second pressure value.

8. Method according to claim 6, further comprising the step of outputting an alarm signal upon determining a lack of plausibility of the second pressure value.

9. Computer program product having program code means for executing a method according to claim 1 when the computer program product runs on a processing unit.

10. Computer program product according to claim 9 when it is stored on a computer-readable data carrier.

11. Device for boosting the hydraulic brake pressure in a hydraulic motor vehicle brake system, wherein a first pressure component of a brake pressure in the brake system may be generated in a driver-controlled manner, comprising:
an acquisition device for acquiring a deceleration value that indicates a deceleration of the vehicle; and
a pressure generating device for generating an additional second pressure component of the brake pressure as a function of the deceleration value in such a way that the second pressure component is substantially proportional to the first pressure component.

12. Device according to claim 11, wherein it further comprises a determination device for determining a first pressure value, which is associated with the first pressure component, on the basis of the deceleration value.

13. Device according to claim 11, wherein it further comprises a plausibility checking device for checking the plausibility of a second pressure value, which is determined by means of a pressure sensor and associated with the first pressure component.

14. Device according to claim 11, further comprising a limiting device for limiting one of the second pressure component and the brake pressure.
